(19) United States
(12) Patent Application Publication
(10) Pub. No.: US 2008/0252827 A1
(43) Pub. Date: Oct. 16, 2008

(54) LAMINATED OPTICAL FILM AND PRODUCTION METHOD THEREOF

(75) Inventors: Mariko HIRAI, Ibaraki-shi (JP); Megumi KATO, Ibaraki-shi (JP); Tetsuro IKEDA, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 12/100,846

(22) Filed: Apr. 10, 2008

(30) Foreign Application Priority Data
Apr. 11, 2007 (JP) 2007-103800
Nov. 6, 2007 (JP) 2007-288449
Dec. 6, 2007 (JP) 2007-315433

(51) Int. Cl. G02F 1/1335; G02B 27/26; C03C 27/12

(52) U.S. Cl. 349/96; 359/485; 156/101

(57) ABSTRACT

A laminated optical film according to an embodiment of the present invention includes a long polarizer having an absorption axis in a lengthwise direction and a long optical compensation film. An angle formed by a slow axis of the optical compensation film and the absorption axis of the polarizer is 5 to 85°.

This application claims priority under 35 U.S.C. Section 119 to Japanese Patent Application No. 2007-103800 filed on Apr. 11, 2007, Japanese Patent Application No. 2007-288449 filed on Nov. 6, 2007, and Japanese Patent Application No. 2007-315433 filed on Dec. 6, 2007, which are herein incorporated by reference.

### BACKGROUND OF THE INVENTION

1. Field of the Invention

The present invention relates to a laminated optical film and a production method thereof. More specifically, the present invention relates to a laminated optical film for an image display apparatus such as a liquid crystal display apparatus and a production method thereof.

2. Description of Related Art

In a liquid crystal display apparatus, it is necessary to place polarizers on both sides of a glass substrate (liquid crystal cell) forming the surface of a liquid crystal panel because of an image formation system thereof. Further, for the purpose of optical compensation of a liquid crystal panel, an optical compensation film is placed between a polarizer and a glass substrate. Therefore, a laminated optical film in which a polarizer and an optical compensation film are previously laminated is used. A laminated optical film having an (elliptical) circular polarization function, a so-called (elliptical) circular polarizing plate or the like, is also used in which a polarizer and an optical compensation film are laminated so that an absorption axis of the polarizer and a slow axis of the optical compensation film form a predetermined angle in an in-plane direction for the purpose of enhancing the brightness of a liquid crystal panel.

The above (elliptical) circular polarizing plate is produced, for example, by placing a polarizer and an optical compensation film so that an absorption axis and a slow axis respectively form a predetermined angle with respect to an end side serving as a reference, followed by cutting and attaching. However, there is a problem that the polarizer itself has no elasticity, which makes it impossible to attach the polarizer and the optical compensation film to each other easily. In order to solve this problem, for example, protective films formed of a transparent resin film or the like are attached to both surfaces of a polarizer to form a laminate (so-called polarizing plate), and the polarizer and the optical compensation film are attached to each other (for example, see JP 2005-140980 A). In this case, there are the step of cutting or punching the polarizer (polarizing plate) and the optical compensation film respectively to a predetermined shape, the step of attaching the polarizer and the protective films to each other, and the step of laminating (attaching) the optical compensation film onto the polarizing plate, which increases the possibility that a foreign matter enters between the respective layers. Thus, there arise problems that the foreign matter which enters causes inconvenience, and the transmittance and polarization degree are degraded.

### SUMMARY OF THE INVENTION

The present invention has been made so as to solve the conventional problems as described above, and a principal object of the present invention is to provide a laminated optical film which prevents a foreign matter from entering between a polarizer and an optical compensation film and which is excellent in transmittance and a polarization degree, and a production method thereof.

According to one aspect of the invention, a long laminated optical film is provided. The laminated optical film includes a long polarizer having an absorption axis in a lengthwise direction and an long optical compensation film. An angle formed by a slow axis of the optical compensation film and the absorption axis of the polarizer is 5 to 850.

In one embodiment of the invention, the laminated optical film further includes another long optical compensation film placed on a side of the polarizer opposite to the optical compensation film.

In another embodiment of the invention, a refractive index ellipsoid of the optical compensation film has a relationship of nx>ny≧nz and a Nz coefficient of 1 to 1.8.

In still another embodiment of the invention, the optical compensation film contains at least one thermoplastic resin selected from a group consisting of a norbornene-based resin, a cellulose-based resin, a polycarbonate-based resin, and a polyester-based resin.

In still another embodiment of the invention, the optical compensation film is obtained by oblique stretching.

In still another embodiment of the invention, the laminated optical film includes an adhesive layer between the polarizer and the optical compensation film. The adhesive layer is formed of an adhesive composition containing a polyvinyl alcohol-based resin, a cross-linking agent, and a metal compound colloid having an average particle diameter of 1 to 100 nm.

In still another embodiment of the invention, the laminated optical film further includes a long protective film placed on a side of the polarizer opposite to the optical compensation film.

In still another embodiment of the invention, the laminated optical film has a roll shape.

According to another aspect of the invention, a production method for a laminated optical film is provided. The production method for a laminated optical film includes laminating a long polarizer having an absorption axis in a lengthwise direction and an long optical compensation film via an adhesive composition while transporting each of the polarizer and the optical compensation film in lengthwise directions so that the lengthwise direction of the polarizer is aligned with the lengthwise direction of the optical compensation film. The polarizer and the optical compensation film were laminated so that an angle formed by a slow axis of the optical compensation film and an absorption axis of the polarizer is 5 to 85°.

In one embodiment of the invention, the production method for a laminated optical film further includes laminating a long protective film on a side of the polarizer opposite to the optical compensation film.

In another embodiment of the invention, the production method for a laminated optical film further includes cutting or punching the polarizer and the optical compensation film at a time after laminating the polarizer and the optical compensation film.

In still another embodiment of the invention, the adhesive composition contains a polyvinyl alcohol-based resin, a cross-linking agent, and a metal compound colloid having an average particle diameter of 1 to 100 nm.

According to still another aspect of the invention, a laminated optical film is provided. The laminated optical film is produced by the production method for a laminated optical film.

According to still another aspect of the invention, a liquid crystal panel is provided. The liquid crystal panel includes a liquid crystal cell and a laminated optical film produced by the production method for a laminated optical film. The laminated optical film is placed on a viewer side of the liquid crystal cell, and the optical compensation film of the laminated optical film is placed closer to a viewer side.

According to the present invention, use of an long optical compensation film can prevent a foreign matter from entering between a polarizer and an optical compensation film, whereby a laminated optical film which can be excellent in transmittance and a polarization degree and a production method of the optical compensation film can be provided.

### BRIEF DESCRIPTION OF THE DRAWINGS

FIG. 1A is a schematic cross-sectional view of a laminated optical film according to one preferred embodiment of the present invention, and FIG. 1B is a schematic cross-sectional view of a laminated optical film according to another preferred embodiment of the present invention.

FIG. 2 is an exploded perspective view illustrating an optical axis of each layer forming the laminated optical film shown in FIGS. 1A and 1B.

FIG. 3 is a schematic plan view illustrating one example of oblique stretching.

FIG. 4 is a schematic view showing one step in one example of a production method for a laminated optical film of the present invention.

FIG. 5A is a schematic cross-sectional view of a liquid crystal panel according to one preferred embodiment of the present invention, and FIG. 5B is a schematic cross-sectional view of a liquid crystal panel according to another preferred embodiment of the present invention.

### DETAILED DESCRIPTION OF THE PREFERRED INVENTION

Hereinafter, the present invention will be described by way of illustrative embodiments with reference to the drawings.

Hereinafter, although the present invention will be described by way of a preferred embodiment, the present invention is not limited thereto.

### DEFINITIONS OF TERMS AND SYMBOLS

The definitions of terms and symbols used in the present specification are as follows.

(1) Refractive index (nx, ny, nz)

“nx” denotes a refractive index in a direction (i.e., a slow axis direction) in which a refractive index in a plane is maximum, “ny” denotes a refractive index in a direction perpendicular to a slow axis in a plane, and “nz” denotes a refractive index in a thickness direction.

(2) In-Plane Retardation (Re)

An in-plane retardation (Re) refers to an in-plane retardation of a layer (film) at a wavelength of 590 nm at 23° C. unless otherwise specified. Re is obtained by Re=(nx−ny)×d, when d (nm) is a thickness of a layer (film). In this specification, Re(550) refers to an in-plane retardation of a layer (film), at a wavelength of 550 nm.

(3) Thickness Direction Retardation (Rth)

A thickness direction retardation (Rth) refers to a retardation in a thickness direction of a layer (film) at a wavelength of 590 nm at 23° C. unless otherwise specified. Rth is obtained by Rth=(nx−nz)×d, when d (nm) is a thickness of a layer (film). In this specification, Rth(550) refers to a thickness direction retardation of a layer (film) at a wavelength of 550 nm.

(4) Nz Coefficient

An Nz coefficient is obtained by Nz=Rth/Re.

(5) λ/4 plate

“λ/4 plate” refers to an electrooptic birefringent plate that rotates a polarization plane of a light beam, which has a function of causing an optical path difference of a ¼ wavelength between linear polarized light beams that vibrate in directions perpendicular to each other. More specifically, the “λ/4 plate” refers to a plate that functions so that the phase between an ordinary ray component and an extraordinary ray component is shifted by a ¼ cycle and converts circular polarized light into plane polarized light (or plane polarized light into circular polarized light).

(6) λ/2 plate

“λ/2 plate” refers to an electrooptic birefringent plate that rotates a polarization plane of a light beam and has a function of causing an optical path difference of a ½ wavelength between linear polarized light beams that vibrate in directions perpendicular to each other. More specifically, the “λ/2 plate” refers to a plate that functions so that the phase between an ordinary ray component and an extraordinary ray component is shifted by a ½ cycle.

### A. Entire Configuration of a Laminated Optical Film

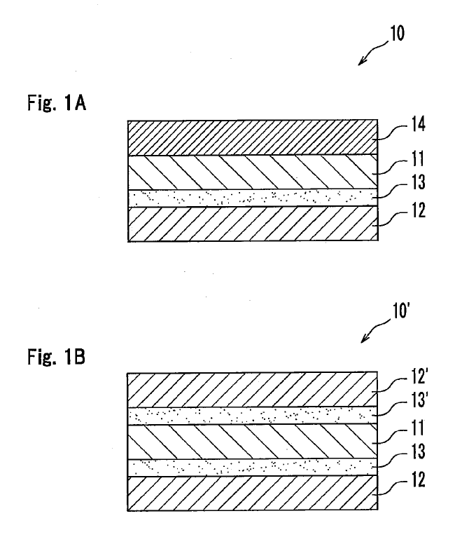

FIG. 1A is a schematic cross-sectional view of a laminated optical film according to a preferred embodiment of the present invention. A laminated optical film 10 includes a polarizer 11 and an optical compensation film 12. Further, the laminated optical film 10 includes an adhesive layer 13 between the polarizer 11 and the optical compensation film 12, and includes a protective film 14 placed on a side of the polarizer 11 opposite to the optical compensation film 12. The polarizer 11, the optical compensation film 12, and the protective film 14 have a long shape. FIG. 1B is a schematic cross-sectional view of a laminated optical film according to another preferred embodiment of the present invention. A laminated optical film 10′ further includes another optical compensation film 12′ placed on a side of the polarizer 11 opposite to the optical compensation film 12, in addition to the polarizer 11 and the optical compensation film 12. Further, the laminated optical film 10′ includes an adhesive layer 13 between the polarizer 11 and the optical compensation film 12, and includes an adhesive layer 13′ between the polarizer 11 and another optical compensation film 12′. The polarizer 11, and the optical compensation films 12 and 12′ have a long shape. In this specification, a “long shape” refers to a shape having a length (lengthwise direction) that is 10 times or more the width (width direction). Thus, a laminated optical film excellent in transmittance and a polarization degree can be obtained by using an optical compensation film having a long shape. Preferably, the laminated optical film of the present invention has a roll shape.

Although not shown, the laminated optical film further includes a protective film placed between the polarizer 11 and the optical compensation films 12 and 12′, and/or on a side of the optical compensation film 12′ opposite to the polarizer 11. As illustrated, in the case where the laminated optical film does not have a protective film between the polarizer 11 and the optical compensation films 12 and 12′, the optical compensation films 12 and 12′ can also function as a protective film of the polarizer. Such a configuration can contribute to the reduction in a thickness of the laminated optical film. Although not shown, the laminated optical film of the present invention can have still another optical compensation layer and the like, if required.

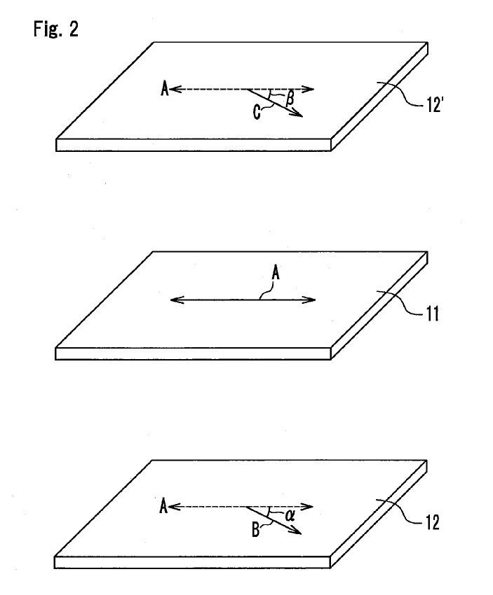

FIG. 2 is an exploded perspective view illustrating an optical axis of each layer constituting the laminated optical films 10 and 10′ shown in FIGS. 1A and 1B (the adhesive layers 13 and 13′, and the protective film 14 are not shown). The polarizer 11 has a long shape, and has an absorption axis A in a lengthwise direction thereof.

An angle α formed by the absorption axis A of the polarizer 11 and a slow axis B of the optical compensation film 12 is 5 to 85°. The angle α can be set to any suitable value within the above range depending upon the optical properties and the like of the optical compensation film 12. For example, in the case where the optical compensation film 12 can function as a λ/4 plate, the angle α is preferably 43.0 to 47.0°, more preferably 44.0 to 46.0°, and particularly preferably 44.5 to 45.5°. In the case where the optical compensation film 12 can function as a λ/2 plate, the angle α is preferably 13.0 to 17.0°, more preferably 14.0 to 16.0°, and particularly preferably 14.5 to 15.5°. In the case where the optical compensation film 12 can function as a λ/2 plate, the laminated optical films 10 and 10′ preferably include an additional optical compensation layer capable of functioning as a λ/4 plate on a side of the optical compensation film 12 opposite to the polarizer 11. An angle (clockwise direction) formed by the slow axis of the optical compensation layer and the absorption axis of the polarizer is preferably 73.0 to 77.0°, more preferably 74.0 to 76.0°, and particularly preferably 74.5 to 75.5°. Such a configuration enables a circular polarization function to be exhibited in a wide wavelength range. In FIG. 2, although the angle α is defined in a clockwise direction with respect to the absorption axis A, the angle α may be defined in a counterclockwise direction.

An angle β formed by the absorption axis A of the polarizer 11 and a slow axis C of another optical compensation film 12′ can be set to any suitable value depending upon the optical properties and the like of the optical compensation film 12′. The angle β is typically 5 to 85°. The optical compensation film 12′ can preferably function as a λ/4 plate. According to such a configuration, for example, in the case of producing a liquid crystal display apparatus by placing the laminated optical film 10′ on a viewer side of the liquid crystal cell, and placing the optical compensation film 12′ on a viewer side (the optical compensation film 12 is on a liquid crystal cell side), polarized light output from the polarizer 11 can be circularly polarized light by the optical compensation film 12′. Because of this, for example, even in the case where a screen of the liquid crystal display apparatus is viewed through a polarization lens such as a sunglass, excellent visibility can be obtained. Specifically, even in the case where the absorption axis of the polarization lens and the absorption axis of the polarizer 11 placed on the viewer side of the liquid crystal display apparatus are substantially perpendicular to each other, an image displayed on the screen can be recognized visually. In the case where the optical compensation film 12′ functions as a λ/4 plate, an angle β is preferably 43.0 to 47.0°, more preferably 44.0 to 46.0°, and particularly preferably 44.5 to 45.5°. In FIG. 2, although the angle β is defined in a clockwise direction with respect to the absorption axis A, the angle β may be defined in a counterclockwise direction.

### A-1. Polarizer

Any appropriate polarizer may be employed as the above-mentioned polarizer 11 in accordance with a purpose. Examples thereof include: a film prepared by adsorbing a dichromatic substance such as iodine or a dichromatic dye on a hydrophilic polymer film such as a polyvinyl alcohol-based film, a partially formalized polyvinyl alcohol-based film, or a partially saponified ethylene/vinyl acetate copolymer-based film and uniaxially stretching the film; and a polyene-based aligned film such as a dehydrated product of a polyvinyl alcohol-based film or a dechlorinated product of a polyvinyl chloride-based film. Of those, a polarizer prepared by adsorbing a dichromatic substance such as iodine on a polyvinyl alcohol-based film and uniaxially stretching the film is particularly preferable because of high polarized dichromaticity. A thickness of the polarizer is not particularly limited, but is generally about 1 to 80 μm.

The polarizer prepared by adsorbing iodine on a polyvinyl alcohol-based film and uniaxially stretching the film may be produced by, for example: immersing a polyvinyl alcohol-based film in an aqueous solution of iodine for coloring; and stretching the film to a 3 to 7 times the length of the original length. The aqueous solution may contain boric acid, zinc sulfate, zinc chloride, or the like as required, or the polyvinyl alcohol-based film may be immersed in an aqueous solution of potassium iodide or the like. Further, the polyvinyl alcohol-based film may be immersed and washed in water before coloring as required.

Washing the polyvinyl alcohol-based film with water not only allows removal of contamination on a film surface or washes away an antiblocking agent, but also provides an effect of preventing nonuniformity such as uneven coloring by swelling of the polyvinyl alcohol-based film. The stretching of the film may be performed after coloring of the film with iodine, performed during coloring of the film, or performed followed by coloring of the film with iodine. The stretching may be performed in an aqueous solution of boric acid or potassium iodide or in a water bath.

### A-2. Optical Compensation Film

In one embodiment, the above optical compensation film 12 has a refractive index ellipsoid of nx>ny≧nz. Herein, “ny=nz” includes not only the case where ny and nz are exactly equal to each other, but also the case where ny and nz are substantially equal to each other. More specifically, “ny=nz” means that an Nz coefficient (Rth/Re) is more than 0.9 and less than 1.1. An in-plane retardation Re of the optical compensation film 12 is preferably 80 to 300 nm. As described above, in the case where the optical compensation film 12 can function as λ/4 plate, the in-plane retardation Re is more preferably 80 to 190 nm. In the case where the optical compensation film 12 can function as a λ/2 plate, the in-plane retardation Re is more preferably 200 to 300 nm. The Nz coefficient (Rth/Re) of the optical compensation film 12 is preferably 1 to 1.8, and more preferably 1.4 to 1.7.

The above another optical compensation film 12, preferably has a refractive index ellipsoid of nx>ny≧nz. The optical compensation film 12′ can preferably function as a λ/4 plate, as described above. In this case, the in-plane retardation Re of the optical compensation film 12′ is preferably 80 to 190 nm. The Nz coefficient (Rth/Re) of the optical compensation film 12′ can be set to any suitable value. The Nz coefficient is preferably 1 to 1.8, and more preferably 1.4 to 1.7.

The optical compensation film having a refractive index ellipsoid of nx>ny≧nz can be formed of any suitable material. A specific example of the optical compensation film includes a stretched polymer film. As a resin forming the polymer film, any suitable resin can be adopted. Preferably, the optical compensation film includes at least one kind of thermoplastic resin selected from a group consisting of a norbornene-based resin, a cellulose-based resin, a polycarbonate-based resin, and a polyester-based resin.

The above norbornene-based resin is obtained by polymerizing a norbornene-based monomer as a polymerization unit. Examples of the norbornene-based monomer include: norbornene, and its alkyl and/or alkylidene-substituted monomers such as 5-methyl-2-norbornene, 5-dimethyl-2-norbornene, 5-ethyl-2-norbornene, 5-butyl-2-norbornene, 5-ethylidene-2-norbornene, and substituted monomers of norbornene and its alkyl and/or alkylidene-substituted monomers with a polar group such as halogen; dicyclopentadiene, 2,3-dihydrodicyclopentadiene, or the like; dimethanooctahydronaphthalene, its substituted monomers with alkyl and/or alkylidene, and its substituted monomers with a polar group such as halogen, such as 6-methyl-1,4:5,8-dimethano-1,4,4a,5,6,7,8,8a-octahydronaphthalene, 6-ethyl-1,4:5,8-dimethano-1,4,4a,5,6,7,8,8a-octahydronaphthalene, 6-ethyliden-1,4:5,8-dimethano-1,4,4a,5,6,7,8,8a-octahydronaphthalene, 6-chloro-1,4:5,8-dimethano-1,4,4a,5,6,7,8,8a-octahydronaphthalene, 6-cyano-1,4:5,8-dimethano-1,4,4a,5,6,7,8,8a-octahydronaphthalene, 6-pyridyl-1,4:5,8-dimethano-1,4,4a,5,6,7,8,8a-octahydronaphthalene, and 6-methoxycarbonyl-1,4:5,8-dimethano-1,4,4a,5,6,7,8,8a-octahydronaphthalene; and a trimer or tetramer of cyclopentadiene such as 4,9:5,8-dimethano-3a,4,4a,5,8,8a,9,9a-octahydro-1H-benzoindene, or 4, 11:5, 10:6,9-trimethano-3a,4,4a,5,5a,6,9,9a,10,10a,11,11a-dodecahydro-1H-cyclopentaanthracene. The above norbornene-based resin may be a copolymer of a norbornene-based monomer and another monomer.

As the above polycarbonate-based resin, an aromatic polycarbonate is preferably used. The aromatic polycarbonate can be typically obtained by the reaction between a carbonate precursor and an aromatic dihydric phenol compound. Specific examples of the carbonate precursor include phosgene, bischloroformate of dihydric phenols, diphenyl carbonate, di-p-tolylcarbonate, phenyl-p-tolylcarbonate, di-p-chlrophenylcarbonate, and dinaphthylcarbonate. Of those, phosgene and diphenylcarbonate are preferred. Specific examples of the aromatic dihydric phenol compound include: 2,2-bis(4-hydroxyphenyl)propane; 2,2-bis(4-hydroxy-3,5-dimethylphenyl)propane; bis(4-hydroxyphenyl)methane; 1,1-bis(4-hydroxyphenyl)ethane; 2,2-bis(4-hydroxyphenyl)butane; 2,2-bis(4-hydroxy-3,5-dimethylphenyl)butane; 2,2-bis(4-hydroxy-3,5-dipropylphenyl)propane; 1,1-bis(4-hydroxyphenyl)cyclohexane; and 1,1-bis(4-hydroxyphenyl)-3,3,5-trimethylcyclohexane. They may be used alone or in combination. Preferred are: 2,2-bis(4-hydroxyphenyl)propane; 1,1-bis(4-hydroxyphenyl)cyclohexane; and 1,1-bis(4-hydroxyphenyl)-3,3,5-trimethylcyclohexane. In particular, 2,2-bis(4-hydroxyphenyl)propane and 1,1-bis(4-hydroxyphenyl)-3,3,5-trimethylcyclohexane are preferably used in combination.

As the above cellulose-based resin, a cellulose ester is preferably used. Any appropriate cellulose ester may be employed as the cellulose ester. Specific examples thereof include organic acid esters such as cellulose acetate, cellulose propionate, and cellulose butyrate. The cellulose ester may be a mixed organic acid ester in which hydroxyl groups of cellulose are partly substituted by an acetyl group and a propionyl group. The cellulose ester is produced, for example, by a method described in paragraphs [0040] and [0041] of JP 2001-188128 A.

The cellulose ester has a weight average molecular weight (Mw) of preferably 30,000 to 500,000, more preferably 50,000 to 400,000, and particularly preferably 80,000 to 300,000 determined through gel permeation chromatography (GPC) by using a tetrahydrofuran solvent. When a weight average molecular weight of a cellulose ester within the above ranges, a polymer film with excellent mechanical strength, solubility, forming property, and casting workability can be obtained.

Examples of the above polyester-based resin include polyethyleneterephthalate (PET) and polybutyleneterephthalate (PBT).

As a method of forming the above resin into a film shape, any suitable method can be adopted. Examples of the method include heat melt-forming and flow-casting. The heat melt-forming is preferably used. Specific examples of the heat melt-forming include melt extrusion, press forming, inflation forming, injection forming, blow forming, and stretching. Of those, the melt extrusion is preferred. This is because a stretched film excellent in mechanical strength, surface precision, and the like can be obtained. The forming condition can be appropriately selected depending upon the purpose of use, the forming method, and the like. According to the melt extrusion, a cylinder temperature is preferably 100 to 600° C., and more preferably 150 to 350° C.

A thickness of the above polymer film (unstretched film) can be set to any suitable value depending upon desired optical properties, a stretching treatment described later, and the like. The thickness is preferably 10 to 300 μm, and more preferably 30 to 200 μm. This is because the thickness in such a range enables stable stretching, whereby a homogenous stretched film can be obtained.

As the above stretching treatment, any suitable stretching method and stretching conditions (e.g., a stretching temperature, a stretching ratio, a stretching direction) can be adopted as long as a long stretched film can be obtained. By appropriately selecting a stretching method and stretching conditions, an optical compensation film having the above desired optical properties (e.g., a refractive index ellipsoid, an in-plane retardation, a thickness direction retardation) can be obtained. As an example of the stretching method, preferably, there is a method of obliquely stretching the above unstretched film continuously in a direction of an angle θ with respect to a width direction of the film. By adopting such a method, a long stretched film having an alignment axis (slow axis) at an angle θ with respect to the width direction of the film is obtained, whereby a lamination method (e.g., roll-to-roll) described later can be performed. Consequently, a foreign matter can be prevented from entering between a polarizer and an optical compensation film, and a laminated optical film excellent in transmittance and a polarization degree can be obtained.

The above angle θ can be set to any suitable value depending upon the purpose. The angle θ is typically 5 to 85°. The angle θ can be set to any suitable value within the above range depending upon desired optical properties and the like. For example, in the case where the optical compensation film can function as a λ/4 plate, the angle θ is preferably 43.0 to 47.0°, more preferably 44.0 to 46.0°, and particularly preferably 44.5 to 45.5°. In the case where the optical compensation film can function as a λ/2 plate, the angle θ is preferably 73.0 to 77.0, more preferably 74.0 to 76.0°, and particularly preferably 74.5 to 75.5°. As a method of stretching a film obliquely, any suitable method can be adopted without any particular limit, as long as a film can be stretched continuously in a direction of an angle θ with respect to a width direction of the film, and an alignment axis of a polymer is tilted at a desired angle. As a stretching machine used for oblique stretching, for example, there is a tenter stretching machine capable of applying a feeding force or a pulling force, or a drawing force each having different rates in right and left directions in lateral and/or longitudinal directions. Examples of the tenter stretching machine include a lateral uniaxial stretching machine and a simultaneous biaxial stretching machine. Any suitable stretching machine can be used as long as a long film can be obliquely stretched continuously.

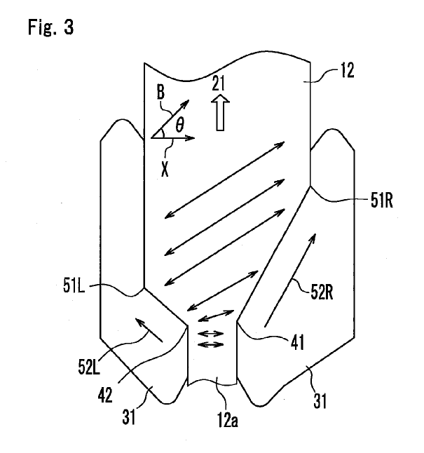

FIG. 3 shows an example of the above oblique tenter stretching. As shown in FIG. 3, an unstretched film 12a is stretched obliquely using right and left tenters 31 and 31, while being transported in a predetermined direction (for example, a longitudinal direction) 21. A film 12a chucked at predetermined positions 41 and 42 can be stretched obliquely by being moved to a position 51L at a rate 52L to the left side and being moved to a position 51R at a rate 52R to the right side (in the illustrated example, rate 52L<rate 52R), whereby a long stretched film 12 can be obtained. The speed ratio (rate difference) between the right and left tenters can be set to any suitable value depending upon the above desired angle θ. The speed ratio is typically 1 to 50%, preferably 2 to 10%, and more preferably 5 to 10%. FIG. 3 shows an example in which the film is stretched obliquely at an angle θ in a counterclockwise direction with respect to a width direction X, and an alignment axis (slow axis) may be in a B direction.

Examples of the oblique stretching include methods described in JP 50-83482 A, JP 2-113920 A, JP 3-182701 A, JP 2000-9912 A, JP2002-86554A, and JP2002-22944 A in addition to the above method.

The temperature during the above oblique stretching is preferably Tg −30° C. to Tg +60° C., and more preferably Tg −10° C. to Tg +50° C., assuming that the glass transition temperature of a resin forming the above polymer film (unstretched film) is Tg. Further, the stretching ratio is typically 1.01 to 30 times, preferably 1.01 to 10 times, and more preferably 1.01 to 5 times.

The thickness of the film obtained by the above oblique stretching is typically 20 to 80 μm, preferably 30 to 60 μm, and more preferably 30 to 45 μm.

### A-3. Adhesive Layer

As an adhesive forming the above adhesive layers 13 and 13′, any suitable adhesive composition can be adopted. Preferably, the adhesive layers 13 and 13′ are formed of an adhesive composition containing a polyvinyl alcohol-based resin, a cross-linking agent, and a metal compound colloid with an average particle diameter of 1 to 100 nm.

Examples of the above polyvinyl alcohol-based resin include a polyvinyl alcohol resin and a polyvinyl alcohol resin containing an acetoacetyl group. The polyvinyl alcohol resin containing an acetoacetyl group is preferred since durability can be enhanced.

Examples of the above-mentioned polyvinyl alcohol-based resin include: a saponified polyvinyl acetate and derivatives of the saponified product; a saponified product of a copolymer obtained by copolymerizing vinyl acetate with a monomer having copolymerizability; and a modified polyvinyl alcohol obtained by modifying polyvinyl alcohol to acetal, urethane, ether, graft, or phosphate. Examples of the monomer include unsaturated carboxylic acids such as maleic acid (anhydrides), fumaric acid, crotonic acid, itaconic acid, and (meth) acrylic acid and esters thereof; α-olefin such as ethylene and propylene; (sodium) (meth)allylsulfonate; sodium sulfonate (monoalkylmalate); sodium disulfonate alkylmalate; N-methylol acrylamide; alkali salts of acrylamide alkylsulfonate; N-vinylpyrrolidone; and derivatives of N-vinylpyrrolidone. Those resins may be used alone or in combination.

The polyvinyl alcohol-based resin has an average degree of polymerization of preferably about 100 to 5,000, and more preferably 1,000 to 4,000, from a view point of adhesion property. The polyvinyl alcohol-based resin has an average degree of saponification of preferably about 85 to 100 mol %, and more preferably 90 to 100 mol %, from a viewpoint of adhesion property.

The above polyvinyl alcohol-based resin containing an acetoacetyl group is obtained, for example, by reacting a polyvinyl alcohol-based resin with diketene by any method. Specific examples thereof include a method of adding diketene to a dispersion in which a polyvinyl alcohol-based resin is dispersed in a solvent such as acetic acid, a method of adding diketene to a solution in which a polyvinyl alcohol-based resin is dissolved in a solvent such as dimethylformamide or dioxane, and a method of bringing diketene gas or liquid diketene into direct contact with a polyvinyl alcohol-based resin.

The acetoactyl group modification degree of the above polyvinyl alcohol-based resin containing an acetoacetyl group is typically 0.1 mol % or more, preferably about 0.1 to 40 mol %, more preferably 1 to 20 mol %, and particularly preferably 2 to 7 mol %. When the modification degree is less than 0.1 mol %, water resistance may be insufficient. When the modification degree exceeds 40 mol %, the effect of the enhancement of water resistance is small. The acetoacetyl group modification degree is a value measured by NMR.

As the cross-linking agent, any appropriate cross-linking agent may be employed. Preferably, a compound having at least two functional groups each having reactivity with a polyvinyl alcohol-based resin can be used as a cross-linking agent. Examples of the compound include: alkylene diamines having an alkylene group and two amino groups such as ethylene diamine, triethylene diamine, andhexamethylenediamine; isocyanates such as tolylenediisocyanate, hydrogenated tolylene diisocyanate, trimethylene propane tolylene diisocyanate adduct, triphenylmethane triisocyanate, methylene bis(4-phenylmethane)triisocyanate, isophorone diisocyanate, and ketoxime blocked compounds thereof or phenol blocked compounds thereof; epoxides such as ethylene glycol diglycidyl ether, polyethylene glycol diglycidyl ether, glycerin di- or triglycidyl ether, 1,6-hexane dial diglycidyl ether, trimethylol propane triglycidyl ether, diglycidyl aniline, and diglycidyl amine; monoaldehydes such as formaldehyde, acetaldehyde, propione aldehyde, and butyl aldehyde; dialdehydes such as glyoxal, malondialdehyde, succinedialdehyde, glutardialdehyde, maleic dialdehyde, and phthaldialdehyde; an amino-formaldehyde resin such as a condensate of formaldehyde with methylolurea, methylolmelamine, alkylated methylolurea, alkylated methylol melamine, acetoguanamine, or benzoguanamine; and salts of sodium, potassium divalent metals or trivalent metals such as magnesium, calcium, aluminum, iron, and nickel and oxides thereof. Of those, an amino-formaldehyde resin and dialdehydes are preferred. As the amino-formaldehyde resin, a compound having a methylol group is preferred, and as the dialdehydes, glyoxal is preferred. Of those, a compound having a methylol group is preferred, and methylol melamine is particularly preferred.

The blending amount of the above cross-linking agent can be appropriately set depending upon the kind of the above polyvinyl alcohol-based resin and the like. Typically, the blending amount of the above cross-linking agent is about 10 to 60 parts by weight, and preferably 20 to 50 parts by weight based on 100 parts by weight of the polyvinyl alcohol-based resin. This is because the cross-linking agent in such a blending amount is excellent in adhesion. In the case where the blending amount of the cross-linking agent is large, the reaction of the cross-linking agent proceeds in a short period of time, and an adhesive tends to be gelled. Consequently, the usable time (pot life) of the adhesive becomes extremely short, which may make it difficult to use the adhesive industrially. The adhesive of the embodiment of the present invention contains a metal compound colloid described later, so the adhesive can be used with good stability even in the case where the blending amount of the cross-linking agent is large.

The above metal compound colloid can have a configuration in which metal compound fine particles are dispersed in a dispersion medium, and can be electrostatically stabilized due to the interaction between the same charges of the fine particles to have stability perpetually. The average particle diameter of the fine particles forming a metal compound colloid can be any suitable value as long as the optical properties such as polarization properties are not adversely influenced. The average particle diameter is preferably 1 to 100 nm, and more preferably 1 to 50 nm. This is because the fine particles can be dispersed uniformly in an adhesive layer to keep adhesion, and the occurrence of knick defects can be suppressed. The “knick defects” refer to light leakage. The detail thereof will be described later.

As the above metal compound, any suitable compound can be adopted. Examples of the metal compound include a metal oxide such as alumina, silica, zirconia, or titania; a metal salt such as aluminum silicate, calcium carbonate, magnesium silicate, zinc carbonate, barium carbonate, or calcium phosphate; and a mineral such as cerite, talc, clay, or kaolin. As described later, according to the present invention, a metal compound colloid having a positive charge is used preferably. Examples of the metal compound include alumina and titania, and alumina is particularly preferred.

The metal compound colloid is typically present in a state of a colloid solution in which the metal compound colloid is dispersed in a dispersion medium. Examples of the dispersion medium include water and alcohols. The concentration of a solid content in a colloid solution is typically about 1 to 50% by weight, and preferably 1 to 30% by weight. The colloid solution can contain acids such as nitric acid, hydrochloric acid, and acetic acid as a stabilizer.

The blending amount of the above metal compound colloid (solid content) is preferably 200 parts by weight or less, more preferably 10 to 200 parts by weight, much more preferably 20 to 175 parts by weight, and most preferably 30 to 150 parts by weight based on 100 parts by weight of the polyvinyl alcohol-based resin. This is because such a blending amount can suppress the occurrence of knick defects while keeping adhesion.

The adhesive composition of the embodiment of the present invention can contain: a coupling agent such as a silane coupling agent and a titanium coupling agent; various kinds of tackifiers; a UV absorber; an antioxidant; and stabilizers such as a heat-resistant stabilizer and a hydrolysis-resistant stabilizer.

The form of the adhesive composition of the embodiment of the present invention is preferably an aqueous solution (resin solution) The resin concentration is preferably 0.1 to 15% by weight and more preferably 0.5 to 10% by weight in view of application property, storage stability, and the like. The viscosity of the resin solution is preferably 1 to 50 mPa·s. Depending upon the adhesive composition of the embodiment of the present invention, the occurrence of knick defects can be suppressed even in a range of a low viscosity of 1 to 20 mPa·s. The pH of the resin solution is preferably 2 to 6, more preferably 2.5 to 5, much more preferably 3 to 5, and most preferably 3.5 to 4.5. Generally, the surface charge of the metal compound colloid can be controlled by adjusting the pH. The surface charge is preferably a positive charge. Due to the presence of a positive charge, the occurrence of knick defects can be suppressed further. The surface charge can be checked, for example, by measuring a zeta potential with a zeta potential measuring apparatus.

As a method of preparing the above resin solution, any suitable method can be adopted. For example, there is a method of previously mixing a polyvinyl alcohol-based resin with a cross-linking agent and adjusting the mixture to an appropriate concentration, and blending a metal compound colloid with the resultant mixture. Alternatively, after a polyvinyl alcohol-based resin is mixed with a metal compound colloid, a cross-linking agent can be mixed with the mixture considering a use time and the like. The concentration of the resin solution may be adjusted after preparation of a resin solution.

The thickness of the adhesive layer formed of the above adhesive composition is preferably 10 to 300 nm, more preferably 10 to 200 nm, and particularly preferably 20 to 150 nm.

### A-4. Protective Film

The protective film 14 is formed of any appropriate film which can be used as a protective layer for a polarizer. Specific examples of a material used as a main component of the film include transparent resins such as a cellulose-based resin such as triacetylcellulose (TAC), a polyester-based resin, a polyvinyl alcohol-based resin, a polycarbonate-based resin, a polyamide-based resin, a polyimide-based resin, a polyether sulfone-based resin, a polysulfone-based resin, a polystyrene-based resin, a polynorbornene-based resin, a polyolefin-based resin, a (meth) acrylic resin, and an acetate-based resin. Another example thereof includes a thermosetting resin or a UV-curing resin such as a (meth) acrylic-based resin, an urethane-based resin, a (meth) acrylic urethane-based resin, an epoxy-based resin, or a silicone-based resin. Still another example thereof includes, for example, a glassy polymer such as a siloxane-based polymer. Further, a polymer film described in JP 2001-343529 A (WO 01/37007) may also be used. To be specific, the film can be formed of a resin composition containing a thermoplastic resin having a substituted or unsubstituted imide group on a side chain and a thermoplastic resin having a substituted or unsubstituted phenyl group and a nitrile group on a side chain. A specific example thereof includes a resin composition containing an alternate copolymer of isobutene and N-methylmaleimide and an acrylonitrile-styrene copolymer. The polymer film may be an extruded product of the resin composition, for example.

Glass transition temperature (Tg) of the (meth) acrylic resin is preferably 115° C. or higher, more preferably 120° C. or higher, still more preferably 125° C. or higher, and particularly preferably 130° C. or higher. This is because the (meth) acrylic resin having a glass transition temperature (Tg) of 115° C. or higher can be excellent in durability. The upper limit value of Tg of the (meth)acrylic resin is not particularly limited, but is preferably 170° C. or lower from the viewpoint of formability and the like.

As the (meth)acrylic resin, any appropriate (meth)acrylic resin can be adopted as long as the effects of the present invention are not impaired. Examples of the (meth)acrylic resin include poly(meth)acrylates such as methyl polymethacrylate, a methyl methacrylate-(meth)acrylic acid copolymer, a methyl methacrylate-(meth)acrylate copolymer, a methyl methacrylate-acrylate-(meth)acrylic acid copolymer, a methyl (meth)acrylate-styrene copolymer (MS resin, etc.), and a polymer having an alicyclic hydrocarbon group (e.g., a methyl metharylate-cyclohexyl methacrylate copolymer, a methyl methacrylate-norbornyl (meth)acrylate copolymer). A preferred example includes C₁₋₆ alkyl poly (meth) acrylic acid such as polymethyl (meth)acrylate. A more preferred example includes a methyl methacrylate-based resin containing methyl methacrylate as a main component (50 to 100% by weight, preferably 70 to 100% by weight).

Specific examples of the (meth) acrylic resin include ACRYPET VH and ACRYPET VRL20A manufactured by Mitsubishi Rayon Co., Ltd., a (meth) acrylic resin having a ring structure in molecules described in JP 2004-70296 A, and a (meth) acrylic resin with high Tg obtained by intramolecular cross-linking or intramolecular cyclization reaction.

As the above (meth)acrylic resin, a (meth)acrylic resin having a lactone ring structure is particularly preferred because of high heat resistance, high transparency, and high mechanical strength.

Examples of the (meth) acrylic resin having the lactone ring structure include (meth)acrylic resins having a lactone ring structure described in JP 2000-230016 A, JP 2001-151814 A, JP 2002-120326 A, JP 2002-254544 A, and JP 2005-146084 A.

The mass average molecular weight (which may also be referred to as weight average molecular weight) of the (meth) acrylic resin having a lactone ring structure is preferably 1,000 to 2,000,000, more preferably 5,000 to 1,000,000, much more preferably 10,000 to 500,000, and particularly preferably 50,000 to 500,000.

The glass transition temperature (Tg) of the (meth)acrylic resin having the lactone ring structure is preferably 115° C. or higher, more preferably 125° C. or higher, still more preferably 130° C. or higher, particularly preferably 135° C. or higher, and most preferably 140° C. or higher. This is because the (meth)acrylic resin having a lactone ring structure and having Tg of 115° C. or higher can be excellent in durability. The upper limit value of the Tg of the (meth)acrylic resin having a lactone ring structure is not particularly limited, but is preferably 170° C. or lower from the viewpoint of formability and the like.

In this specification, the term “(meth)acrylic” refers to acrylic and/or methacrylic.

The above protective film 14 is preferably transparent and colorless. The thickness direction retardation Rth of the protective film is preferably −90 nm to +90 nm, more preferably −80 nm to +80 nm, and much more preferably −70 nm to +70 nm.

As the thickness of the above protective film, any suitable thickness can be adopted as long as the above preferred thickness direction retardation Rth can be obtained. The thickness of the protective film is typically 5 mm or less, preferably 1 mm or less, more preferably 1 to 500 μm, and much more preferably 5 to 150 μm.

The side of the protective film opposite to the polarizer can be subjected to hard coat treatment, antireflection treatment, sticking prevention treatment, antiglare treatment, or the like, if required.

As described above, in the case of a cellulose-based film generally used as a protective layer of a polarizer, e.g., a triacetylcellulose film, the thickness direction retardation Rth is about 60 nm at a thickness of 80 μm. In order to obtain a smaller thickness direction retardation Rth, a cellulose-based film with large Rth can be subjected to appropriate treatment for decreasing Rth.

As treatment for decreasing the above thickness direction retardation Rth, any suitable treatment method can be adopted. Examples thereof include a method of attaching a base made of polyethylene terephthalate, polypropylene, or stainless steel with a solvent such as cyclopentanone or methylethylketone applied thereto to a general cellulose-based film, drying the laminate by heating (for example, for about 3 to 10 minutes at about 80 to 150° C.), and thereafter peeling the base; and a method of applying a solution in which a norbornene-based resin, an acrylic resin, or the like is dissolved in a solvent such as cyclopentanone or methylethylketone to a general cellulose-based film, dying the laminate by heating (for example, for about 3 to 10 minutes at 80 to 150° C.), and thereafter peeling the applied film.

Examples of materials forming the above cellulose-based film preferably include aliphatic acid-substituted cellulose-based polymers such as diacetylcellulose and triacetylcellulose. Although the acetic acid substitution degree in generally used triacetylcellulose is about 2.8, the thickness direction retardation Rth can be controlled to be small preferably by controlling the acetic acid substitution degree to 1.8 to 2.7, and more preferably by controlling the propionic acid substitution degree to 0.1 to 1.

By adding a plasticizer such as dibutylphthalate, p-toluenesulfonanilide, or acetyltriethyl citrate to the above aliphatic acid-substituted cellulose-based polymer, the thickness direction retardation Rth can be controlled to be small. The adding amount of the plasticizer is preferably 40 parts by weight or less, more preferably 1 to 20 parts by weight, and much more preferably 1 to 15 parts by weight with respect to 100 parts by weight of the aliphatic acid-substituted cellulose-based polymer.

The treatment methods of decreasing the above thickness direction retardation Rth may be used in an appropriate combination. The thickness direction retardation Rth (550) of the protective film obtained by the treatment is preferably −20 nm to +20 nm, more preferably −10 nm to +10 nm, much more preferably −6 nm to +6 nm, and particularly preferably −3 nm to +3 nm. The in-plane retardation Re(550) of the protective film is preferably 0 nm or more and 10 nm or less, more preferably 0 nm or more and 6 nm or less, and much more preferably 0 nm or more and 3 nm or less.

As the thickness of the above protective film, any suitable thickness can be adopted as long as the above preferred thickness direction retardation Rth can be obtained. The thickness of the above protective film is preferably 20 to 200 μm, more preferably 30 to 100 μm, and much more preferably 35 to 95 μm.

### A-5. Others

The laminated optical film of the present invention can further include another optical compensation layer as described above. The optical compensation layer can have any suitable optical properties. Examples of the form thereof include a stretched film of a polymer film and a liquid crystal applied layer. Examples of the resin forming the polymer film include a polycarbonate-based resin and a norbornene-based resin. Examples of the stretching method include uniaxial stretching and biaxial stretching. Another optical compensation layer can exhibit a circular polarization function in a wide wavelength range, together with the above optical compensation film, for example.

### B. Production Method

A production method for a laminated optical film of the present invention includes the step of laminating a long polarizer having an absorption axis in a lengthwise direction and an long optical compensation film so that the lengthwise direction of the polarizer is aligned with the lengthwise direction of the optical compensation film, while transporting the polarizer and the optical compensation film in the respective lengthwise directions. Thus, by laminating the polarizer and the optical compensation film while transporting them, a foreign matter can be prevented from entering between the polarizer and the optical compensation film, and a laminated optical film that can be excellent in transmittance and a polarization degree can be provided. The long polarizer preferably has a roll shape. The long optical compensation film preferably has a roll shape.

The above polarizer and the above optical compensation film are laminated via an adhesive composition. Specifically, an adhesive composition is applied to one of surfaces of a polarizer or one of surfaces of an optical compensation film, and thereafter, the polarizer and the optical compensation film are attached to each other, followed by drying. As the adhesive composition, any suitable adhesive composition can be adopted. Preferably, the adhesive composition described in the above item A-3 is used. Examples of the method of applying an adhesive composition include a roll method, a spray method, and an immersion method. Further, preferably, the adhesive composition is applied so that the thickness after drying becomes larger than the average particle diameter of the metal compound colloid. The thickness after drying is typically 10 to 300 nm, preferably 10 to 200 nm, and more preferably 20 to 150 nm. By setting the thickness in the range, sufficient adhesive strength can be obtained. The drying temperature is typically 5 to 150° C., and preferably 30 to 120° C. The drying time is typically 120 seconds or more, and preferably 300 seconds or more.

The above polarizer and the optical compensation film are laminated so that an angle formed by the slow axis of the optical compensation film and the absorption axis of the polarizer becomes 5 to 85°. As described above, in the case where the optical compensation film can function as a λ/4 plate, the above angle is preferably 43.0 to 47.0°, more preferably 44.0 to 46.0°, and particularly preferably 44.5 to 45.5°. In the case where the optical compensation film can function as a λ/2 plate, the above angle is preferably 13.0 to 17.0°, more preferably 14.0 to 16.0°, and particularly preferably 14.5 to 15.5°.

As shown in FIG. 1B, in the case where the laminated optical film further includes another optical compensation film, it is preferred that the another optical compensation film is also laminated on a polarizer by the same method as the above.

The production method for a laminated optical film of the present invention can further include the step of laminating a long protective film on one side or both sides of a polarizer. In the case of producing the laminated optical film as shown in FIG. 1A, the production method can further include the step of laminating a long protective film on a side of a polarizer, which is opposite to an optical compensation film. A preferred example of the lamination method includes a method of laminating a polarizer and a protective film so that the lengthwise direction of the polarizer is aligned with the lengthwise direction of the protective film while transporting the polarizer and the protective film in the respective lengthwise directions. The long protective film preferably has a roll shape. The polarizer and the protective film are laminated via any suitable adhesive layer. For formation of the adhesive layer, the adhesive composition described in the above item A-3 can be used.

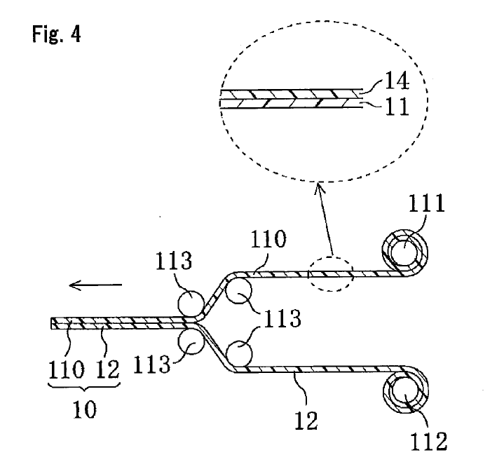

FIG. 4 shows one step in one example of the production method for a laminated optical film of the present invention. As shown in FIG. 4, a laminate 110 in which a protective film 14 is laminated on a polarizer 11 previously and an optical compensation film 12 with an adhesive composition (not shown) applied thereto are sent out to the arrow direction, and attached to each other while the respective lengthwise directions of the laminate and the optical compensation film are aligned. More specifically, the polarizer 11 and the optical compensation film 12 are laminated continuously by roll-to-roll. In FIG. 4, reference numerals 111 and 112 denote rolls for winding a film forming each layer, and reference numeral 113 denotes a guide roll for attaching the films to each other.

The production method for a laminated optical film of the present invention preferably further includes the step of laminating a polarizer and an optical compensation film via an adhesive composition, and thereafter, cutting or punching the polarizer and the optical compensation film at a time. In the case of laminating the above protective film, it is preferred that the protective film be also cut or punched together with the polarizer and the optical compensation film. As cutting or punching, any suitable method can be adopted. Needless to say, the laminated optical film obtained by cutting or punching is not necessarily long shape.

In the case where the laminated optical film of the present invention further includes another optical compensation layer, the optical compensation layer is laminated via any suitable pressure-sensitive adhesive layer or adhesive layer.

### C. Liquid Crystal Panel

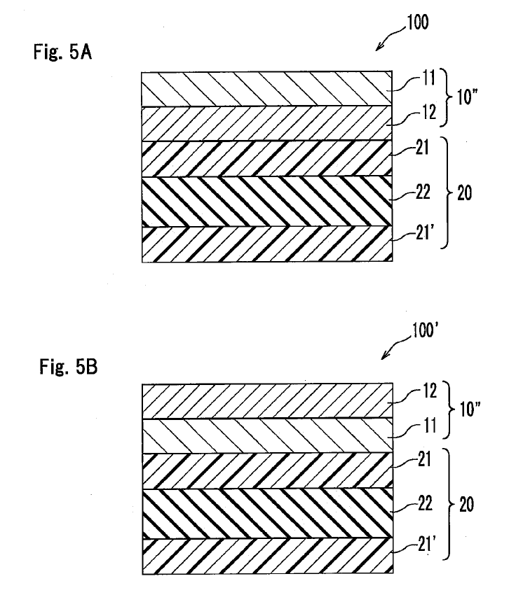

The laminated optical film of the present invention can be used preferably for a liquid crystal display apparatus (liquid crystal panel). The liquid crystal panel of the present invention includes a liquid crystal cell and the laminated optical film of the present invention. FIG. 5A is a schematic cross-sectional view of a liquid crystal panel 100 according to a preferred embodiment of the present invention. The liquid crystal panel 100 includes a liquid crystal cell 20 and a laminated optical film 10″ placed on one side of the liquid crystal cell 20. The laminated optical film 10″ includes a polarizer 11 and an optical compensation film 12. In the embodiment shown in FIG. 5A, the laminated optical film 10″ is placed so that the optical compensation film 12 is placed on the liquid crystal cell 20 side. In this case, the laminated optical film 10″ may be placed on a backlight side or a viewer side of the liquid crystal cell 20.

FIG. 5B is a schematic cross-sectional view of the liquid crystal panel 100′ according to another preferred embodiment of the present invention. In the liquid crystal panel 100′, the laminated optical film 10″ is placed so that the polarizer 11 is placed on the liquid crystal cell 20 side. In this case, the laminated optical film 10″ is preferably placed on the viewer side of the liquid crystal cell 20. Specifically, the laminated optical film 10″ is placed so that the optical compensation film 12 is placed closer to the viewer side than the polarizer 11. In the case where such an arrangement is adopted, and the optical compensation film 12 can function as a λ/4 plate, the optical compensation film 12 can convert polarized light output from the polarizer 11 into circularly polarized light. Consequently, even in the case where the liquid crystal panel is viewed via a polarization lens such as a sunglass, excellent visibility can be obtained. Specifically, even in the case where the absorption axis of the polarization lens and the absorption axis of the polarizer 11 placed on the viewer side of the liquid crystal panel are substantially perpendicular to each other, an image displayed on the liquid crystal panel can be visually recognized. Although not shown, the liquid crystal panel of the present invention can include another optical element.

The liquid crystal cell 20 is provided with a pair of substrates 21 and 21′ and a liquid crystal layer 22 as a display medium held between the substrates 21 and 21′. One substrate (color filter substrate) is provided with color filters and black matrix (both not shown). The other substrate (active matrix substrate) is provided with: a switching element (typically TFT) (not shown) for controlling electrooptic properties of liquid crystals; a scanning line (not shown) for providing a gate signal to the switching element and a signal line (not shown) for providing a source signal thereto; and a pixel electrode (not shown). Note that the color filters may be provided in the active matrix substrate side. A distance (cell gap) between the substrates 21 and 21′ is controlled by a spacer (not shown). An aligned film (not shown) formed of, for example, polyimide is provided on a side of each of the substrates 21 and 21′, which is in contact with the liquid crystal layer 22.

The production method for a liquid crystal panel of the present invention includes the step of producing a laminated optical film by the production method described in the above item B, and the step of laminating the obtained laminated optical film on the liquid crystal cell. In the lamination step, the laminated optical film and the liquid crystal cell can be laminated via any suitable pressure-sensitive adhesive. Further, typically, the obtained laminated optical film is cut or punched into a desired size, and thereafter, the laminated optical film is laminated on a liquid crystal cell.

### EXAMPLES

Hereinafter, the present invention will be described specifically by way of examples. It should be noted that the present invention is not limited to these examples. The method of measuring a retardation value of an optical compensation film is as follows.

### (Measurement of a Retardation Value)

A retardation value was automatically measured with KOBRA-WPR manufactured by Oji Scientific Instruments. The measurement wavelength was 590 nm, and the measurement temperature was 23° C.

### Example 1

### Production of a Polarizer

A long polyvinyl alcohol film was dyed in an aqueous solution containing iodine. After that, the film was uniaxially stretched by 6 times between rolls having different speed ratios in an aqueous solution containing boric acid, whereby a long polarizer having an absorption axis in a lengthwise direction was obtained. The long polarizer was wound up after being stretched to obtain a winding body.

### (Production of an Optical Compensation Film)

An unstretched film (thickness: 60 μm) obtained by subjecting a norbornene-based resin (average molecular weight: 35,000, Tg: 140° C.) to melt extrusion was chucked at a tenter stretching machine and heated to 120° C. The film was stretched in a transportation direction during stretching in a lateral direction at a speed ratio (rate difference) of 5% of the right and left tenters while being transported in a longitudinal direction, whereby an long optical compensation film (stretched film) with a thickness of 35 μm was obtained.

Thus, a long optical compensation film having a slow axis in a direction at 45° in a clockwise direction with respect to the lengthwise direction was obtained. The long optical compensation film was wound up to obtain a winding body. The in-plane retardation Re of the optical compensation film was 140 nm, and the Nz coefficient thereof was 1.6.

### (Protective Film)

As a protective film, a long triacetylcellulose film (thickness: 40 μm, KC4UYW (trade name), manufactured by Konica Minolta) was used. The protective film was prepared as a winding body. The in-plane retardation Re of the protective film was 5 nm, and the thickness direction retardation Rth thereof was 45 nm.

### (Preparation of an Adhesive Composition)

100 parts by weight of a polyvinyl alcohol-based resin containing an acetoacetyl group (average polymerization degree: 1200, saponification degree: 98.5 mol %, acetoacetylation degree: 5 mol %) and 50 parts by weight of methylolmelamine were dissolved in pure water under a temperature condition of 30° C., whereby an aqueous solution with a solid content concentration of 3.7% was obtained. Then, 18 parts by weight of an aluminacolloid aqueous solution (average particle diameter: 15 nm, solid content concentration: 10%, positive charge) were added with respect to 100 parts by weight of the aqueous solution to prepare an adhesive composition. The viscosity of the adhesive composition was 9.6 mPa·s. The pH of the adhesive composition was 4 to 4.5.

### (Production of a Laminated Optical Film)

After 30 minutes from the preparation of the adhesive composition, while each of the optical compensation film and the protective film was fed from a winding body, an adhesive composition was applied to each one surface so that the thickness after drying was 80 nm, whereby an adhesive layer was formed. After that, the optical compensation film with the adhesive layer formed thereon was attached to one surface of a polarizer fed from the winding body and the protective film with the adhesive layer formed thereon was attached to the other surface of the polarizer with a roll machine while they were being run, and wound up after the passage through an atmosphere at 55° C. for 6 minutes to produce a long laminated optical film. The optical compensation film was attached to the laminated optical film so that the slow axis of the optical compensation film was 45°.in a clockwise direction with respect to the absorption axis of the polarizer. The thickness of the laminated optical film thus obtained was 103 μm.

### Example 2

A laminated optical film was obtained in the same way as in Example 1, except that the following optical compensation film was used, and the optical compensation film was attached so that the slow axis thereof was 165° in a clockwise direction with respect to the absorption axis of the polarizer. The thickness of the laminated optical film thus obtained was 103 μm.

### (Production of an Optical Compensation Film)

An unstretched film (thickness: 60 μm) obtained by subjecting a norbornene-based resin (average molecular weight: 35,000, Tg: 140° C.) to melt extrusion was chucked at a tenter stretching machine and heated to 120° C. The film was stretched in a transportation direction during stretching in a lateral direction at a speed ratio (rate difference) of 10% of the right and left tenters while being transported in a longitudinal direction, whereby an long optical compensation film (stretched film) with a thickness of 35 μm was obtained.

Thus, a long optical compensation film having a slow axis in a direction at 165° in a clockwise direction with respect to the lengthwise direction was obtained. The long optical compensation film was wound up to obtain a winding body. The in-plane retardation Re of the optical compensation film was 270 nm, and the Nz coefficient thereof was 1.

### Example 3

A laminated optical film was produced in the same way as in Example 1, except that an aluminacolloid aqueous solution was not added when an adhesive composition was prepared. The thickness of the laminated optical film thus obtained was 103 μm.

### Example 4

### Production of a Polarizing Plate Roll

After 30 minutes from the preparation of the adhesive composition (see Example 1), while the protective film (see Example 1) was being fed from a winding body, an adhesive composition was applied to one surface of the protective film so that the thickness after drying was 80 nm, whereby an adhesive layer was formed. After that, the protective films with the adhesive layer formed thereon were formed on both surfaces of a polarizer fed from the winding body with a roll machine while they were being run, and wound up after the passage through an atmosphere at 55° C. for 6 minutes to produce a long laminated film (so-called polarizing plate roll)

### (Production of a Laminated Optical Film)

Next, while the polarizing plate roll and the optical compensation film (see Example 1) were being sent out from the winding body, they were attached to each other via an acrylic adhesive (thickness: 12 μm), whereby a long laminated optical film was produced. The optical compensation film was attached so that the slow axis thereof was 45° in a clockwise direction with respect to the absorption axis of the polarizer. The thickness of the laminated optical film thus obtained was 155 μm.

### Comparative Example 1

### Production of a Polarizing Plate Roll

An adhesive composition was prepared in the same way as in Example 1, except that an aluminacolloid aqueous solution was not added. A polarizing plate roll was produced in the same way as in Example 4, except that the adhesive composition was used.

### (Production of an Optical Compensation Film)

A long norbornene-based resin film (Zeonor (trade name) manufactured by ZEON Corporation, thickness: 60 μm, photoelastic coefficient: 3.1×10⁻¹² m²/N) was subjected to fixed-end biaxial stretching by 1.55 times at 150° C., whereby a long film was produced. The thickness of the film was 35 μm, the in-plane retardation Re thereof was 140 nm, the thickness direction retardation Rth thereof was 217 nm, and the Nz coefficient (Rth/Re) thereof was 1.55.

### (Production of a Laminated Optical Film)

Laminate pieces with a predetermined size were cut out from each of the obtained polarizing plate roll and the optical compensation film, and laminated via an acrylic pressure-sensitive adhesive (thickness: 12 μm) to obtain a laminate. At this time, they were laminated so that the slow axis of the optical compensation film was 45° in a counterclockwise direction with respect to the absorption axis of the polarizer.

The obtained laminate was cut out to a size of 100 mm×100 mm to obtain a laminated optical film. The thickness of the laminated optical film thus obtained was 155 μm.

### Comparative Example 2

A laminated optical film was produced in the same way as in Comparative Example 1 except using of the following polarizing plate roll. Note that the optical compensation film was laminated on a side of the polarizing plate roll on which the protective film was not provided. The thickness of the laminated optical film thus obtained was 115 μm.

### (Production of a Polarizing Plate Roll)

After 30 minutes from the preparation of the adhesive composition (see Example 1), while the protective film (see Example 1) was being fed from the winding body, an adhesive composition was applied to one surface of the protective film so that the thickness after drying was 80 nm, whereby an adhesive layer was formed. After that, the protective film with the adhesive layer formed thereon was attached to one surface of a polarizer fed from the winding body with a roll machine while they were being run, and wound up after the passage through an atmosphere at 55° C. for 6 minutes to produce a polarizing plate roll.

The laminated optical films obtained in Examples 1 to 4 were evaluated as follows. Table 1 shows the evaluation results.

### 1. Peeling

The obtained laminated optical film was cut into a size of 50 mm in an absorption axis direction (lengthwise direction) of the polarizer and 25 mm in a transmission axis direction perpendicular in a plane with respect to the absorption axis direction, whereby a sample piece was obtained. The sample piece was immersed in hot water at 60° C. for 5 hours. After immersion, a peeled width from an end of the sample piece (interface with a film adjacent to the polarizer) was measured with a caliper.

### 2. External Appearance (Presence/Absence of Knick Defects)

A sample piece with a size of 1,000 mm×1,000 mm was cut out from the obtained laminated optical film. The sample piece was laminated on another polarizing plate (NPF-SEG1224DU (trade name) manufactured by Nitto Denko Corporation) placed on a black light under a fluorescent lamp. At this time, the sample piece was laminated on another polarizing plate so that the absorption axis of the polarizer of the sample piece was perpendicular to the absorption axis of another polarizing plate. The number of light leakage portions (knick defects) was counted.

TABLE 1

| | Peeling (mm) | Knick defects (number) |
|---|---|---|
| Example 1 | 0.5 | 0 |
| Example 2 | 0.5 | 0 |
| Example 3 | 0.5 | 24 |
| Example 4 | 0.5 | 0 |

It is understood from Table 1 that the occurrence of knick defects can be suppressed by laminating the sample piece on another polarizing plate with an adhesive composition containing an alumina colloid.

The laminated optical films obtained in Examples 1 to 3 and Comparative Examples 1 and 2 were evaluated as follows. Table 2 summarizes the evaluation results.

### 1. Peeling

The obtained laminated optical films were cut into a size of 1,000 mm×1,000 mm (only Examples 1 to 3). The laminated optical films obtained in Comparative Examples 1 and 2 were used as sample pieces as they were.

The sample pieces were immersed in hot water at 60° C. for 5 hours. After immersion, a peeled width from an end of each sample piece (interface with a film adjacent to the polarizer) was measured with a caliper.

### 2. External Appearance (Presence/Absence of Foreign Matters)

10 sample pieces with a size of 1,000 mm×1,000 mm were cut out from the obtained laminated optical films (only Examples 1 to 3). 10 laminated optical films were produced for each of Comparative Examples 1 and 2 and used as sample pieces.

The obtained sample pieces were visually observed under a fluorescent lamp, and the number of foreign matters mixed between the polarizer or the polarizing plate and the adjacent film was checked.

### 3. Optical Properties

A sample piece with a size of 30 mm×45 mm was cut out from the obtained laminated optical film, and a single axis transmittance and a polarization degree were measured using an integrating sphere type spectral transmittance measuring machine (DOT-3C (trade name), manufactured by Murakami Color Research Laboratory Co., Ltd.). The sample piece was cut out so that the angle formed by the long side of the sample piece and the absorption axis of the polarizer was 45°.

The single axis transmittance was measured by setting the sample piece so that the protective film was placed on a light source side of the measuring machine.

The polarization degree was calculated from the results obtained by measuring the parallel transmittance and the perpendicular transmittance. The parallel transmittance and the perpendicular transmittance were measured by preparing two sample pieces for each of the parallel transmittance and the perpendicular transmittance, and placing the two sample pieces so that the protective films were laminated. Herein, the two sample pieces were set so that the absorption axis of one sample piece was perpendicular to the absorption axis of the other sample piece.

TABLE 2

| | Single axis | Polarization | | Foreign matter |
|---|---|---|---|---|
| | transmittance | degree | Peeling | (number/one |
| | (%) | (%) | (mm) | sample piece) |
| Example 1 | 42.8 | 100 | 0.5 | 0 |
| Example 2 | 42.8 | 100 | 0.5 | 0 |
| Example 3 | 42.8 | 100 | 0.5 | 0 |
| Comparative | 43.8 | 99.9 | 0.5 | 3 |
| Example 1 | | | | |
| Comparative | 43.5 | 99.9 | 3 | 3 |
| Example 2 | | | | |

As is apparent from Table 2, no foreign matters were confirmed in Examples 1 to 3. On the other hand, foreign matters were confirmed in Comparative Examples land 2. From this fact, it can be considered that foreign matters can be prevented from entering by laminating the layers while transporting them. Further, the laminated optical films obtained in the examples were excellent in both a single axis transmittance and a polarization degree. In Comparative Example 2 in which the polarizer and the optical compensation film were laminated via an acrylic pressure-sensitive adhesive, peeling was larger than that in the other examples.

The laminated optical film of the present invention can be preferably applied to various kinds of image display apparatuses. The use of the image display apparatus is not particularly limited. Specifically, the image display apparatus can be used for OA equipment such as a personal computer monitor, a laptop computer, and a copying machine; portable equipment such as a mobile telephone, a watch, a digital camera, a personal digital assistant (PDA), and a portable game machine; household electric equipment such as a video camera, a liquid crystal television, and an electronic oven; on-vehicle equipment such as a back monitor, a monitor for a car navigation system, and a car audio; exhibition equipment such as a monitor for information for a commercial store; security equipment such as a surveillance monitor; and caregiving and medical equipment such as a monitor for caregiving and a medical monitor.

What is claimed is:

1. A long laminated optical film, comprising:
a long polarizer having an absorption axis in a lengthwise direction; and
a long optical compensation film,
wherein an angle formed by a slow axis of the optical compensation film and the absorption axis of the polarizer is 5 to 85°.

2. A laminated optical film according to claim 1, further comprising another long optical compensation film placed on a side of the polarizer opposite to the optical compensation film.

3. A laminated optical film according to claim 1, wherein a refractive index ellipsoid of the optical compensation film has a relationship of nx>ny≧nz and a Nz coefficient of 1 to 1.8.

4. A laminated optical film according to claim 2, wherein a refractive index ellipsoid of the another optical compensation film has a relationship of nx>ny≧nz and a Nz coefficient of 1 to 1.8.

5. A laminated optical film according to claim 1, wherein the optical compensation film contains at least one thermoplastic resin selected from a group consisting of a norbornene-based resin, a cellulose-based resin, a polycarbonate-based resin, and a polyester-based resin.

6. A laminated optical film according to claim 2, wherein the another optical compensation film contains at least one thermoplastic resin selected from a group consisting of a norbornene-based resin, a cellulose-based resin, a polycarbonate-based resin, and a polyester-based resin.

7. A laminated optical film according to claim 1, wherein the optical compensation film is obtained by oblique stretching.

8. A laminated optical film according to claim 2, wherein the another optical compensation film is obtained by oblique stretching.

9. A laminated optical film according to claim 1, comprising an adhesive layer between the polarizer and the optical compensation film,
wherein the adhesive layer is formed of an adhesive composition containing a polyvinyl alcohol-based resin, a cross-linking agent, and a metal compound colloid having an average particle diameter of 1 to 100 nm.

10. A laminated optical film according to claim 2, comprising an adhesive layer between the polarizer and the another optical compensation film,
wherein the adhesive layer is formed of an adhesive composition containing a polyvinyl alcohol-based resin, a cross-linking agent, and a metal compound colloid having an average particle diameter of 1 to 100 nm.

11. A laminated optical film according to claim 1, further comprising a long protective film placed on a side of the polarizer opposite to the optical compensation film.

12. A laminated optical film according to claim 1, which has a roll shape.

13. A production method for a laminated optical film, comprising
laminating a long polarizer having an absorption axis in a lengthwise direction and an long optical compensation film via an adhesive composition while transporting each of the polarizer and the optical compensation film in lengthwise directions so that the lengthwise direction of the polarizer is aligned with the lengthwise direction of the optical compensation film,
wherein the polarizer and the optical compensation film were laminated so that an angle formed by a slow axis of the optical compensation film and an absorption axis of the polarizer is 5 to 85°.

14. A production method for a laminated optical film according to claim 13, further comprising laminating a long protective film on a side of the polarizer opposite to the optical compensation film.

15. A production method for a laminated optical film according to claim 13, further comprising cutting or punching the polarizer and the optical compensation film at a time after laminating the polarizer and the optical compensation film.

16. A production method for a laminated optical film according to claim 13, wherein the adhesive composition contains a polyvinyl alcohol-based resin, a cross-linking agent, and a metal compound colloid having an average particle diameter of 1 to 100 nm.

17. A laminated optical film produced by the production method for a laminated optical film according to claim 13.

18. A liquid crystal panel comprising:
a liquid crystal cell; and
a laminated optical film produced by the production method for a laminated optical film according to claim 13,
wherein the laminated optical film is placed on a viewer side of the liquid crystal cell, and the optical compensation film of the laminated optical film is placed closer to a viewer side.
